(19) United States
(12) Patent Application Publication
(10) Pub. No.: US 2025/0053636 A1
(43) Pub. Date: Feb. 13, 2025

(54) COMPUTER SYSTEM PROTECTION

(71) Applicant: Nokia Technologies Oy, Espoo (FI)

(72) Inventor: Fabian WIACEK, Wroclaw (PL)

(21) Appl. No.: 18/715,149

(22) PCT Filed: Dec. 10, 2021
(86) PCT No.: PCT/FI2021/050865

§ 371 Date: May 31, 2024

(51) Int. Cl. G06F 21/44

(52) U.S. Cl. CPC G06F 21/44

(57) ABSTRACT

An apparatus comprising at least one processor; and at least one memory including computer program code; the at least one memory and the computer program code configured to, with the at least one processor, cause the apparatus to perform: receiving at least one input for execution by a computer system (302), wherein the at least one input is received with appropriate authorisation for execution by the computer system; determining if the at least one input should be passed to the computer system for execution (304, 306); and if it is determined that the at least one input should not be passed to the computer system for execution, preventing execution of the at least one input by the computer system (308).

### TECHNOLOGICAL FIELD

Embodiments of the present disclosure relate to computer system protection. Some relate to computer system protection in software controlled devices.

### BACKGROUND

Some electronic devices, such as some user devices, are configured to receive and execute inputs, such as commands and/or procedures.

It would be desirable to enhance receipt and execution of inputs by an electronic device.

### BRIEF SUMMARY

According to various, but not necessarily all, embodiments there is provided an apparatus comprising
at least one processor; and
at least one memory including computer program code;
the at least one memory and the computer program code configured to, with the at least one processor, cause the apparatus to perform:
receiving at least one input for execution by a computer system, wherein the at least one input is received with appropriate authorisation for execution by the computer system;
determining if the at least one input should be passed to the computer system for execution; and
if it is determined that the at least one input should not be passed to the computer system for execution, preventing execution of the at least one input by the computer system.

In some examples, the at least one memory and computer program code configured to, with the at least one processor, cause the apparatus to perform:
If it is determined that the at least one input should be passed to the computer system for execution, passing the at least one input for execution by the computer system.

In some examples, preventing execution of the at least one input comprises blocking or changing the at least one input.

In some examples, changing the at least one input comprises changing at least one command of the at least one input and/or changing at least one target of the at least one input.

In some examples, appropriate authorisation comprises authorisation for the at least one input to pass through any firewalls protecting the computer system.

In some examples, appropriate authorisation comprises administrator authorisation for the computer system.

In some examples, the computer system comprises a filesystem and/or operating system.

In some examples, determining if the at least one input should be passed to the computer system comprises comparing the at least one input against at least one reference input set.

In some examples, determining if the at least one input should be passed to the computer system comprises encoding the at least one input into a bit representation for comparison with a reference input set.

In some examples, the reference input set is user defined.

In some examples, if there is a match between the at least one input and the reference input set, the at least one input is accepted for execution by the computer system.

In some examples, the at least input comprises one or more of:
a command;
a procedure;
an instruction;
   a function; and
an option.

In some examples, the at least one memory and the computer program code configured to, with the at least one processor, cause the apparatus to perform:
determining that an authorised physical device has been physically connected to a device; and
based, at least in part, on determining that the authorised physical device has been physically connected, changing a state of the apparatus.

In some examples, changing a state of the apparatus comprises changing how the apparatus performs determining if the at least one input should be passed to the computer system for execution.

In some examples, changing how the apparatus performs determining if the at least one input should be passed to the computer system for execution comprises changing a reference input set or bypassing the determination.

In some examples, the at least one memory and the computer program code configured to, with the at least one processor, cause the apparatus to perform:
changing an output caused by at least one input.

According to various, but not necessarily all, embodiments there is provided an electronic device comprising an apparatus as described herein and at least one computer system.

According to various, but not necessarily all, embodiments there is provided a method comprising:

receiving at least one input for execution by a computer system, wherein the at least one input is received with appropriate authorisation for execution by the computer system;
determining if the at least one input should be passed to the computer system for execution; and
if it is determined that the at least one input should not be passed to the computer system for execution, preventing execution of the at least one input by the computer system.

In some examples, the method comprising:
If it is determined that the at least one input should be passed to the computer system for execution, passing the at least one input for execution by the computer system.

In some examples, preventing execution of the at least one input comprises blocking or changing the at least one input.

In some examples, changing the at least one input comprises changing at least one command of the at least one input and/or changing at least one target of the at least one input.

In some examples, appropriate authorisation comprises authorisation for the at least one input to pass through any firewalls protecting the computer system.

In some examples, appropriate authorisation comprises administrator authorisation for the computer system.

In some examples, the computer system comprises a filesystem and/or operating system.

In some examples, determining if the at least one input should be passed to the computer system comprises comparing the at least one input against a reference input set.

In some examples, determining if the at least one input should be passed to the computer system comprises encoding the at least one input into a bit representation for comparison with a reference input set.

According to various, but not necessarily all, embodiments there is provided a computer program comprising instructions for causing an apparatus to perform:

receiving at least one input for execution by a computer system, wherein the at least one input is received with appropriate authorisation for execution by the computer system;
determining if the at least one input should be passed to the computer system for execution; and
if it is determined that the at least one input should not be passed to the computer system for execution, preventing execution of the at least one input by the computer system.

In some examples, the computer program comprising instructions for causing an apparatus to perform:
If it is determined that the at least one input should be passed to the computer system for execution, passing the at least one input for execution by the computer system.

In some examples, preventing execution of the at least one input comprises blocking or changing the at least one input.

In some examples, changing the at least one input comprises changing at least one command of the at least one input and/or changing at least one target of the at least one input.

In some examples, appropriate authorisation comprises authorisation for the at least one input to pass through any firewalls protecting the computer system.

In some examples, appropriate authorisation comprises administrator authorisation for the computer system.

In some examples, the computer system comprises a filesystem and/or operating system.

In some examples, determining if the at least one input should be passed to the computer system comprises comparing the at least one input against a reference input set.

In some examples, determining if the at least one input should be passed to the computer system comprises encoding the at least one input into a bit representation for comparison with a reference input set.

According to various, but not necessarily all, embodiments there is provided an apparatus comprising means for:

receiving at least one input for execution by a computer system, wherein the at least one input is received with appropriate authorisation for execution by the computer system;
determining if the at least one input should be passed to the computer system for execution; and
if it is determined that the at least one input should not be passed to the computer system for execution, preventing execution of the at least one input by the computer system.

In some examples, the means are configured to:
If it is determined that the at least one input should be passed to the computer system for execution, pass the at least one input for execution by the computer system.

In some examples, preventing execution of the at least one input comprises blocking or changing the at least one input.

In some examples, changing the at least one input comprises changing at least one command of the at least one input and/or changing at least one target of the at least one input.

In some examples, appropriate authorisation comprises authorisation for the at least one input to pass through any firewalls protecting the computer system.

In some examples, appropriate authorisation comprises administrator authorisation for the computer system.

In some examples, the computer system comprises a filesystem and/or operating system.

In some examples, determining if the at least one input should be passed to the computer system comprises comparing the at least one input against a reference input set.

In some examples, determining if the at least one input should be passed to the computer system comprises encoding the at least one input into a bit representation for comparison with a reference input set.

According to various, but not necessarily all, embodiments there is provided an apparatus comprising
at least one processor; and
at least one memory including computer program code;
the at least one memory and the computer program code configured to, with the at least on processor, cause the apparatus at least to perform at least a part of one or more methods disclosed herein.

According to various, but not necessarily all, embodiments there is provided an apparatus comprising means for performing at least part of one or more methods disclosed herein.

According to various, but not necessarily all, embodiments there is provided examples as claimed in the appended claims.

The description of a function should additionally be considered to also disclose any means suitable for performing that function.

### BRIEF DESCRIPTION

Some examples will now be described with reference to the accompanying drawings in which:

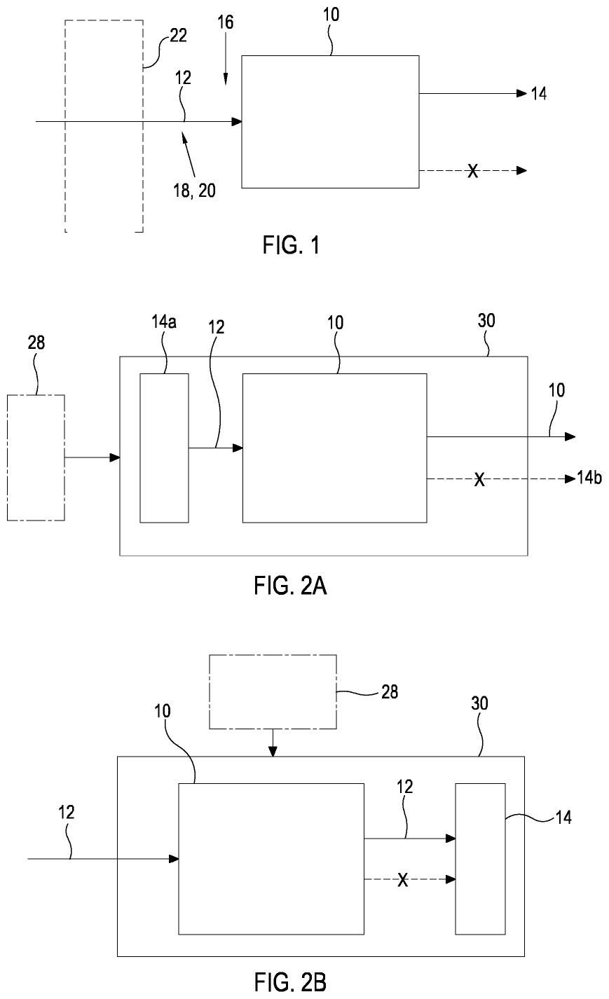

FIG. 1 shows an example of the subject matter described herein;

FIG. 2A shows another example of the subject matter described herein;

FIG. 2B shows another example of the subject matter described herein;

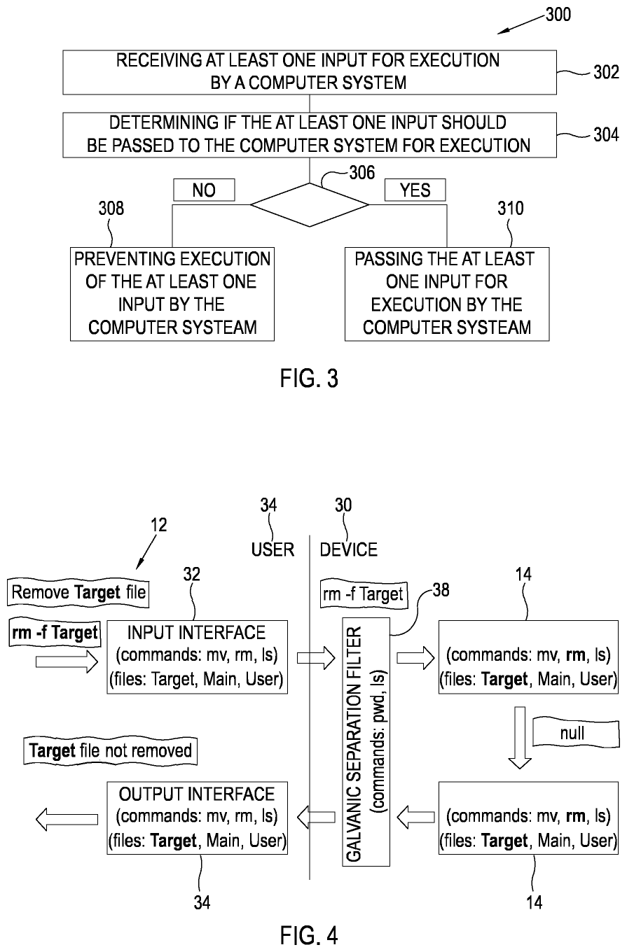

FIG. 3 shows another example of the subject matter described herein;

FIG. 4 shows another example of the subject matter described herein;

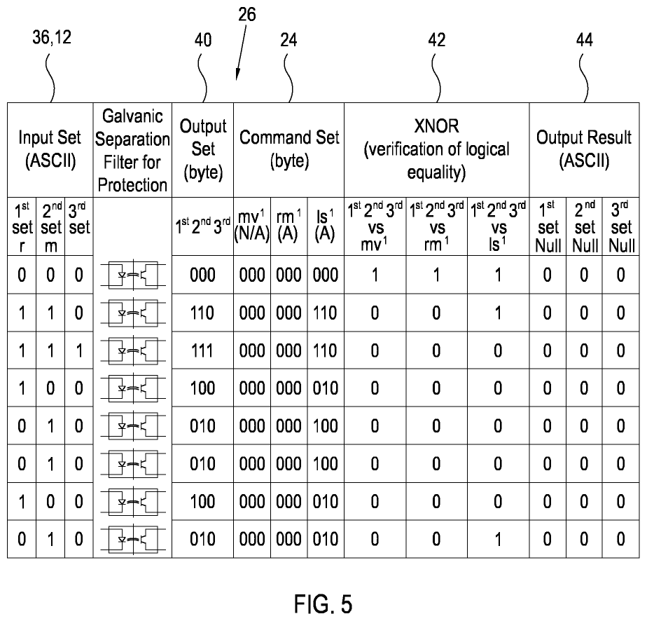

FIG. 5 shows another example of the subject matter described herein;

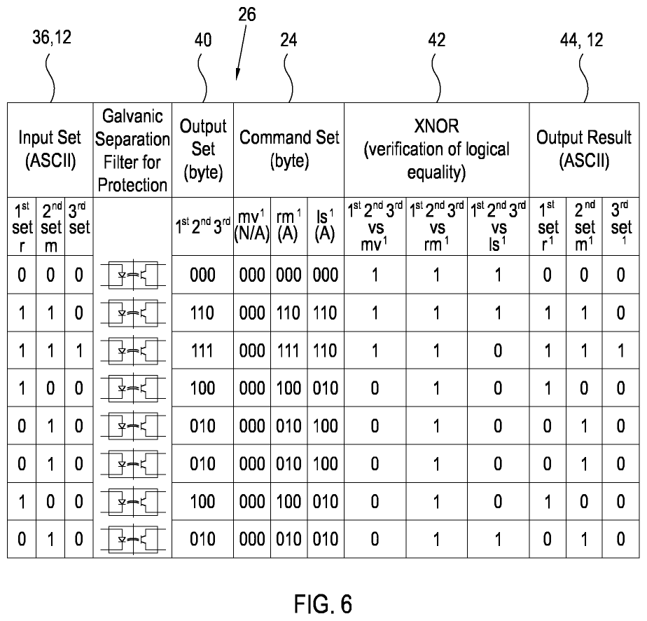

FIG. 6 shows another example of the subject matter described herein;

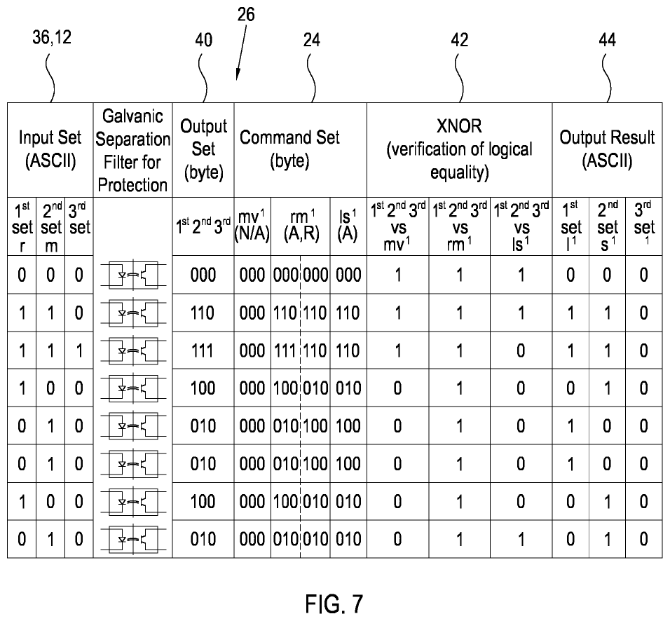

FIG. 7 shows another example of the subject matter described herein;

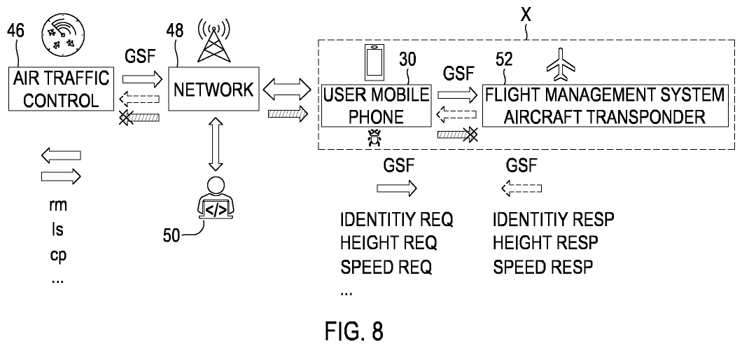

FIG. 8 shows another example of the subject matter described herein;

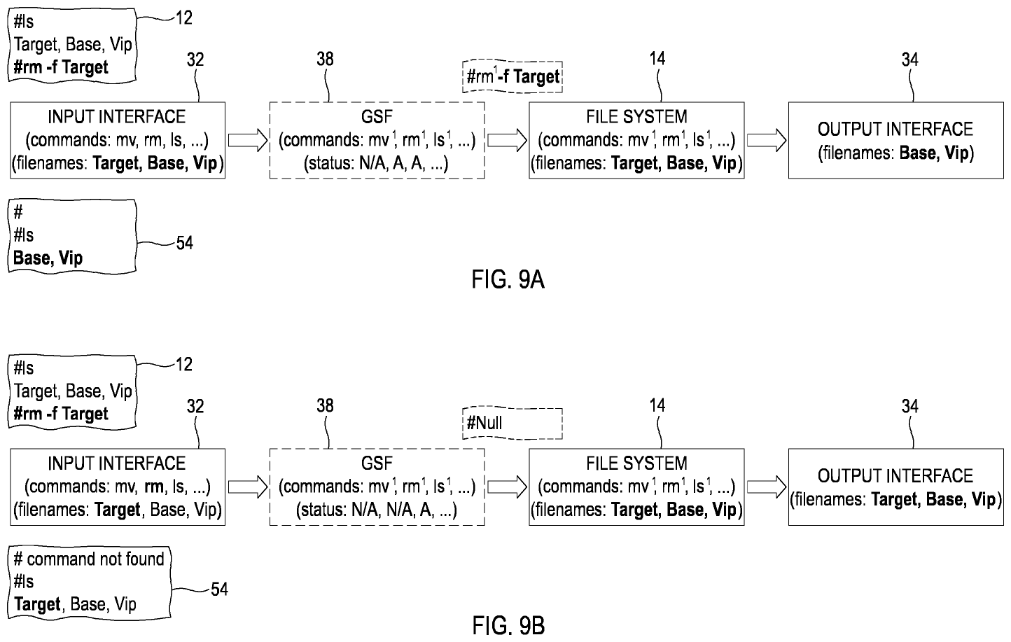

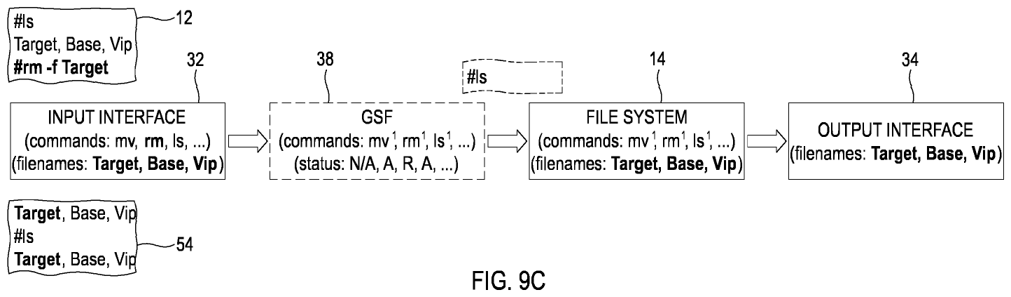

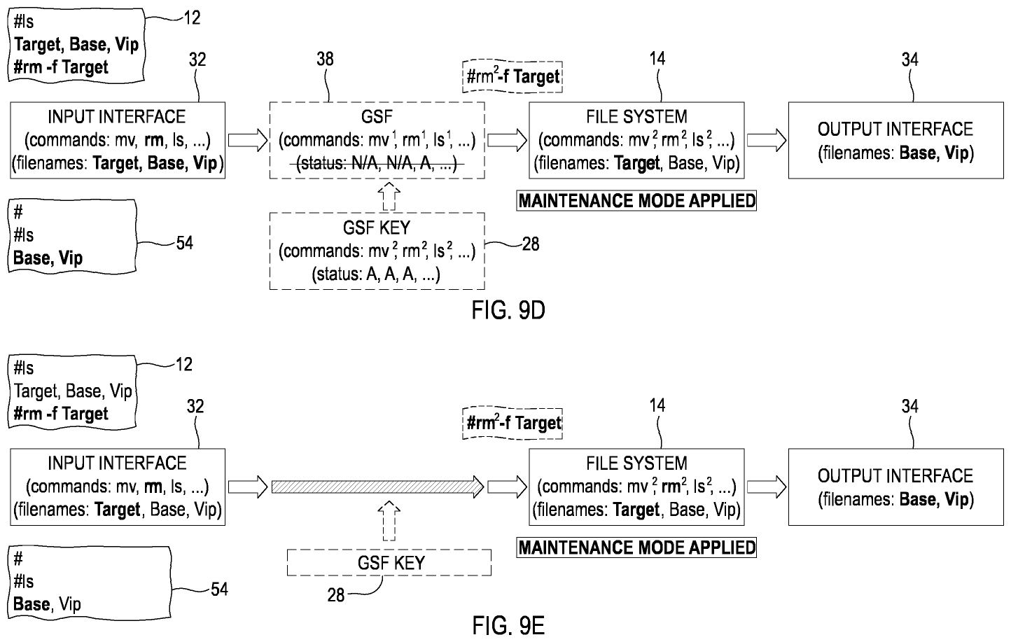

FIG. 9A shows another example of the subject matter described herein;

FIG. 9B shows another example of the subject matter described herein;

FIG. 9C shows another example of the subject matter described herein;

FIG. 9D shows another example of the subject matter described herein;

FIG. 9E shows another example of the subject matter described herein;

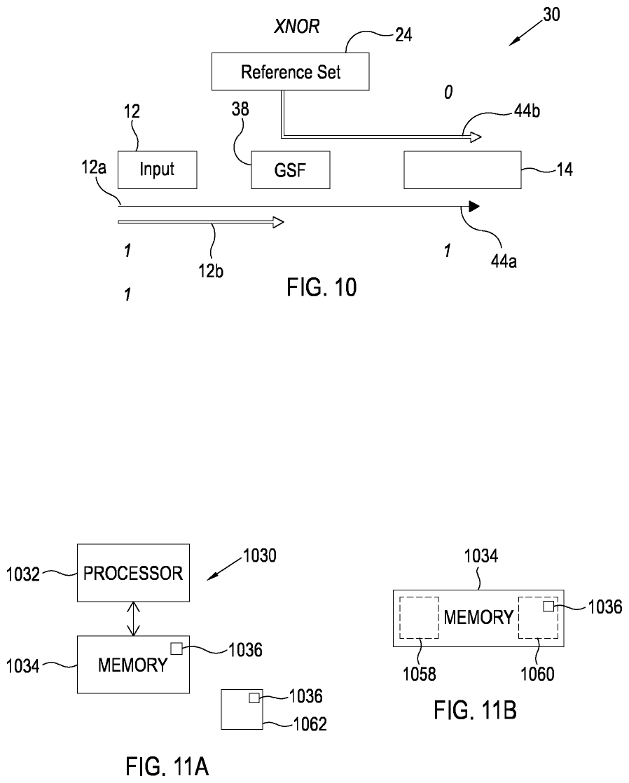

FIG. 10 shows another example of the subject matter described herein;

FIG. 11A shows another example of the subject matter described herein; and

FIG. 11B shows another example of the subject matter described herein;

### DETAILED DESCRIPTION

Examples of the disclosure relate to apparatus, methods and/or computer programs for and/or involved in computer system protection.

Some examples of the disclosure relate to preventing execution of one or more malicious inputs by a computer system.

The following description and FIGs describe various examples of an apparatus 10 comprising means for:

receiving at least one input 12 for execution by a computer system 14, wherein the at least one input 12 is received with appropriate authorization 16 for execution by the computer system 14;
determining if the at least one input should be passed to the computer system 14 for execution; and
if it is determined that the at least one input 12 should not be passed to the computer system 14 for execution, preventing execution of the at least one input by the computer system 14.

In examples, the means comprises at least one processor and at least one memory including computer program code.

FIG. 1 schematically illustrates an example of an apparatus 10.

In examples, the apparatus 10 is configured to receive at least one input 12 for execution by a computer system 14, the at least one input having and/or comprising appropriate authorization 16 for execution by the computer system 14.

In examples, the at least one input comprises one or more of a command; a procedure; an instruction; a function; and an option.

In examples, the apparatus 10 is configured to determine if the at least one input 12 should be passed to the computer system 14 for execution.

As used herein, the term “determining” (and grammatical variants thereof) can include, at least: calculating, computing, processing, deriving, investigating, looking up (for example, looking up in a table, a database or another data structure), ascertaining and the like. Also, “determining” can include receiving (for example, receiving information), accessing (for example, accessing data in a memory) and the like. Also, “determining” can include resolving, selecting, choosing, establishing, and the like.

In examples, the apparatus 10 is configured to, if it is determined that the at least one input 12 should not be passed to the computer system 14 for execution, prevent execution of the at least one input 12 by the computer system 14.

This is illustrated in the example of FIG. 1 by the dashed arrow with an ‘X’ through it pointing to the right from the apparatus 10.

In examples, preventing execution of the at least one input comprises blocking or changing the at least one input 12.

In examples, changing the at least one input 12 comprises changing at least one command 18 of the at least one input 12 and/or changing at least one target 20 of the at least one input 12.

In examples, the apparatus 10 is configured to, if it is determined that the at least one input 12 should be passed to the computer system 14 for execution, pass the at least one input 12 for execution by the computer system 14.

This is illustrated in the example of FIG. 1 by the solid arrow pointing to the right from the apparatus 10.

In examples, appropriate authorization 16 comprises authorization for the at least one input 12 to pass through any firewalls 22 protecting the computer system 14.

This is illustrated in the example of FIG. 1 by the arrow labelled ‘12’ pointing towards the apparatus 10 and passing through the dashed box labelled ‘22’ representing at least one firewall 22 protecting the computer system 14.

In examples, appropriate authorization 16 comprises administrator authorization for the computer system 14.

In examples, the computer system 14 comprises a filesystem and/or operating system.

In examples, the apparatus 10 can comprise any number of additional elements not illustrated in the example of FIG. 1.

In examples, the apparatus 10 can be located in the same device as the computer system 14 or in a separate device from the computer system 14.

In examples, the functionality provided by the apparatus 10 can be considered to be located in the same device as the computer system 14 or in a separate device from the computer system 14.

That is, in examples, the apparatus 14 operates on input(s) 12 for execution on the device in which the apparatus 10 is located (for example FIG. 2A) or on input(s) 12 for execution on a device that is separate from the device in which the apparatus 10 is located (for example FIG. 2b).

FIG. 2A schematically illustrates an example of an electronic device 30. The electronic device can be any suitable electronic device 30.

In the illustrated example, the electronic device 30 comprises a computer system 14 and an apparatus 10. The apparatus 10 can be the apparatus 10 of FIG. 1 and/or an apparatus as described herein.

In examples, the electronic device 30 can be considered an apparatus.

In the example of FIG. 2A the apparatus 10 receives one or more inputs 12 from the computer system 14a for execution by a computer system 14b on a separate device, the one or more inputs 12 received with appropriate authorization 16 for execution by the computer system 14b.

However, in examples, the one or more inputs 12 can be received from any suitable source or sources, for example any suitable source or sources in the device 30.

In examples, the one or more inputs 12 can originate from one or more user inputs.

In the example of FIG. 2A, the apparatus 10 is configured to determine if the one or more inputs 12 should be passed to the computer system 14b for execution.

FIG. 2B schematically illustrates an example of an electronic device 30. The electronic device can be any suitable electronic device 30.

In the illustrated example, the electronic device 30 comprises a computer system 14 and an apparatus 10. The apparatus 10 can be the apparatus 10 of FIG. 1 and/or an apparatus as described herein.

In examples, the electronic device 30 can be considered an apparatus.

In the example of FIG. 2B the apparatus 10 receives one or more inputs 12 from an external source, for example from the electronic device of FIG. 2A, for execution by the computer system 14 of the electronic device 30, the one or more inputs 12 received with appropriate authorization 16 for execution by the computer system 14.

However, in examples, the one or more inputs 12 can be received from any suitable source or sources, for example any suitable source or sources outside the device 30.

In examples, the one or more inputs 12 can originate from one or more user inputs.

In the example of FIG. 2B, the apparatus 10 is configured to determine if the at least one input 12 should be passed to the computer system 14 for execution.

In examples, the apparatus 10, for example the apparatus 10 of FIG. 1, 2A and/or 2B, is configured to determine that an authorized physical device 28 has been physically connected to a device 30; and based, at least in part, on determining that the authorized physical device 28 has been physically connected, changing a state of the apparatus 10.

See for example, FIG. 2A or 2B. This is illustrated in the example of FIG. 2A and 2B by the dot-dashed box to the left of the device 30/above the device 30 and the arrow pointing from the dot-dashed box to the device 30.

In examples, changing a state of the apparatus 10 comprises changing how the apparatus 10 performs determining if the at least one input 12 should be passed to the computer system 14 for execution.

In examples, changing how the apparatus 10 performs determining if the at least one input should be passed to the computer system 14 for execution comprises changing a reference input set 24 or bypassing the determination.

In examples, the apparatus 10 is configured to change an output caused by the at least one input 12.

In examples, the means of the apparatus 10 for providing the functionality described herein can also be configured to provide at least a portion of the functionality of the computer system 14.

For example, the apparatus 10 can comprise at least one processor 1032 and at least one memory 1034 including computer program code 1036, the at least one memory 1034 and the computer program code 1036 configured to, with the at least one processor 1032, cause the apparatus 10 to perform at least part of one or more methods described herein, and also to provide at least part of the functionality of the computer system 14.

In examples, it can be considered that the functionality of the computer system 14, for example operating system and/or filesystem, is behind the barrier of protection provided by the functionality described herein. This means that it is not possible, without an authorized physical device, for example, to change the protection described herein and then access the computer system 14.

In examples, the electronic device 30 of FIG. 2A and/or FIG. 2B, can comprise any number of additional elements not illustrated. For example, the electronic device 30 of FIG. 2A and/or FIG. 2B can comprise one or more user interfaces.

Additionally, or alternatively, one or more elements of the electronic device 30 of FIG. 2A and/or FIG. 2B can be integrated and/or combined.

FIG. 2A and/or FIG. 2B illustrate an electronic device 30 comprising an apparatus 10 as described herein and at least one computer system 14.

FIG. 3 illustrates an example of a method 300.

One or more features discussed in relation to FIG. 3 can be found in one or more of the other figures. During discussion of FIG. 3, reference will be made to other figures for the purposes of explanation.

In examples, method 300 can be considered a method 300 of protecting a computer system 14.

In examples, method 300 can be considered a method 300 of controlling execution of inputs at/by a computer system 14.

In examples, method 300 can be considered a method 300 of preventing malicious attacks on a computer system 14.

In examples, method 300 can be considered a method 300 of protecting functionality of a software-controlled device or devices.

In examples, method 300 can be performed by any suitable apparatus comprising any suitable means for performing the method 300.

In examples, method 300 can be performed by the apparatus of FIGS. 10A and 10B, and/or the apparatus 10 of FIG. 1, and/or the electronic device 30 of FIG. 2A, and/or the electronic device 30 of FIG. 2B.

At block 302, method 300 comprises receiving at least one input 12 for execution by a computer system 14, wherein the at least one input 12 is received with appropriate authorization 16 for execution by the computer system 14.

In examples, receiving at least one input 12 for execution by a computer system 14 can be performed in any suitable way using any suitable method.

In examples, the at least one input 12 can originate from any suitable source or sources.

In examples, the at least one input 12 comprises at least one internal input and/or at least one external input.

In examples, an internal input can be considered an input originating from and/or caused by an apparatus and/or device 30 in and/or on which the method 300 is performed.

For example, the at least one input can originate from and/or be caused by a computer system 14 of the apparatus and/or device 30 in and/or on which the method 300 is performed.

In examples, an external input can be considered an input originating from and/or caused by an apparatus and/or device 30 that is separate from and/or external to an apparatus and/or device in and/or on which the method 300 is performed.

For example, the at least one input can originate from and/or be caused by a first apparatus and/or device 30 and be transmitted to a second apparatus and/or device 30 in and/or on which the method 300 is performed.

In examples, the at least one input 12 can originate from and/or be caused by one or more user inputs. For example, the least one input 12 can originate from and/or be caused by one or more user inputs into the apparatus and/or device 30 in and/or on which the method 300 is performed, and/or one or more user inputs into a separate apparatus and/or device 30.

In examples, the at least one input 12 can have any suitable form. For example, the at least one input 12 can have any suitable form for execution by computer system 14.

In examples, the at least one input 12 can have any suitable form to cause one or more actions to be taken by computer system 14.

For example, the at least one input 12 can have the correct syntax and/or semantics to be executed by computer system 14.

In examples, the at least one input 12 comprises one or more of: a command 18, a procedure, an instruction, and an option.

In examples, a procedure comprises a plurality of commands and/or instructions and/or options.

In examples, a procedure can be considered a sequence of commands and/or instructions.

In examples a procedure can be user defined.

In examples, an option is associated with a command and/or instruction and affects how the associated command and/or instruction is executed.

In examples, an option can be considered a modifier, an adapter, and/or a changer and so on.

In examples, the at least one input 12 can be or comprise a portion of a larger and/or longer input.

For example, for an input 12 in the form command option target, the at least one input can be considered to be the ‘command’, the ‘option’ and/or the ‘target’.

For example, an input 12 for a Unix based computer system 14 can comprise the form ‘rm-f Target’, where ‘Target’ represents a target for the command ‘rm’, for example a file and/or directory and/or one or more special characters and so on.

In examples, ‘rm’ can be considered at least one input 12, and/or ‘-f’ can be considered at least one input, and/or ‘Target’ can be considered at least one input and so on.

In examples, ‘rm-f Target’ can be considered at least one input 12.

In examples, the at least one input 12 can be determined based, at least in part, on the syntax and semantics of the computer system 14.

For example, using computer system 14 specific syntax and semantic, different components of commands or procedures, and data can, in examples, be distinguished.

In examples, different distinguished components can be considered together or separately.

In examples, appropriate authorization 16 for the at least one input 12 can be considered to comprise any suitable authorization 16 to allow computer system 14 to execute and/or respond to and/or act upon the at least one input 12.

In examples, appropriate authorization 16 comprises administrator authorization for the computer system 14.

In examples, appropriate authorization 16 comprises root authorization for the computer system 14.

In examples, at least one input 12 can be considered to have appropriate authorization 16 if the at least one input 12 has been made and/or originated by and/or caused by a user who has entered appropriate login details, such as administrator and/or root user name and password.

In examples, appropriate authorization 16 comprises authorization for the at least one input 12 to pass through and/or avoid any other protection in place to protect the computer system 14.

For example, in examples appropriate authorization 16 comprises authorization for the at least one input 12 to pass through any firewalls 22 protecting the computer system 14.

In examples, the computer system 14 can comprise any suitable system of any suitable apparatus and/or device 30.

In examples, the computer system 14 can comprise any computer system that controls and/or is responsible for control of any suitable functionality of an apparatus and/or device 30.

In examples, the computer system 14 comprises a filesystem and/or operating system. In some examples, the computer system 14 is a filesystem and/or operating system.

For example, the computer system 14 can comprise UNIX-based computer system, WINDOWS-based computer system, LINUX-based computer system, ANDROID OS-based computer system, and/or iOS-based computer system and so on.

Accordingly, in examples, without the inventive disclosure described herein, any input 12 having appropriate authority will be executed by computer system 14, which can, for example, be problematic if login details are intercepted or stolen.

This can be especially problematic in the case that login details that provide full access to the computer system 14, such as administrator and/or root login details, are intercepted or stolen.

At block 304, method 300 comprises determining if the at least one input 12 should be passed to the computer system 14 for execution.

In examples, determining if the at least one input 12 should be passed to the computer system 14 for execution can be performed in any suitable way using any suitable method.

In examples, block 304 can be considered to comprise, determining independently from user access rights if the at least one input 12 should be passed to the computer system 14 for execution.

In examples, passing at least one input 12 to a computer system 14 for execution can be considered transmitting at least one input 12, communicating at least one input 12, allowing at least one input to pass, sending at least one input 12, conveying at least one input 12, and/or communicating at least one input 12 to a computer system 14 for execution.

In examples, determining if the at least one input 12 should be passed to the computer system 14 comprises determining if the at least one input 12 has previously been indicated as allowable and/or acceptable for execution by the computer system 14.

In examples, determining if the at least one input 12 should be passed to the computer system 14 comprises determining if the at least one input 12 has previously been indicated as not allowable and/or not acceptable for execution by the computer system 14.

In examples, determining if the at least one input 12 should be passed to the computer system 14 comprises determining if the at least one input 12 is included in a predetermined set of inputs that are allowable and/or acceptable for execution by the computer system 14.

In examples, determining if the at least one input 12 should be passed to the computer system 14 comprises determining if the at least one input 12 is included in a predetermined set of inputs that are not allowable and/or not acceptable for execution by the computer system 14.

In examples, determining if the at least one input 12 should be passed to the computer system 14 comprises accessing and/or referring to at least one data set.

In examples, determining if the at least one input 12 should be passed to the computer system 14 comprises comparing the at least one input 12 against at least one reference input set 24.

In examples, a reference input set 24 can be considered input information and/or input data against which the at least one input can be compared and/or assessed. For example, a reference input set 24 can comprise a set of inputs. In such examples, the set of inputs in a reference input set 24 can be predetermined allowable or not allowable inputs.

However, in examples, a reference input set 24 can comprise any suitable information to allow a determination of whether the at least one input 12 should be passed to computer system 14 for execution.

Examples of reference input sets are:
Filesystem Procedure Set, which may refer to user defined procedures supported by the given software,
Filesystem Instruction Set, for defined instructions,
Filesystem Command Set, for defined commands, see, for example, FIGS. 5 and 6,
Filesystem Option Set, which may be associated with Command Set,
Filesystem Directory Set, to specify directories or folders of special interest,
Filesystem Filename Set, to specify filenames of special interest.

In examples, comparing the at least one input 12 against and/or with at least one reference input set 24 can be considered searching at least one reference input 24 set based, at least in part, on the at least one input 12, and/or assessing the at least one input 12 against at least one reference input set 24, and/or analyzing the at least one input 12 against at least one reference input set 24 and so on.

In examples, the at least one reference input set 24 is user defined.

In examples, the at least one reference input set 24 is stored in read-only memory 1060 to inhibit alteration of the at least one reference input set 24.

In examples, if there is a match between the at least one input 12 and the reference input set 24, the at least one input 12 is accepted for execution by the computer system 14. See, for example, FIGS. 6 and 7.

In examples, determining if the at least one input 12 should be passed to the computer system 14 comprises processing and/or operating on the at least one input.

In examples, determining if the at least one input 12 should be passed to the computer system 14 comprises encoding the at least one input into a bit representation 26 for comparison with a reference input set 24.

In examples, any suitable bit representation can be used. For example, any suitable number of bits can be used in the bit representation 26.

In examples, a bit-wise comparison between the bit representation and the reference input set 24 can be made.

By way of example, reference is made to FIG. 5.

FIG. 5 illustrates an example of determining if at least one input 12 should be passed to a computer system 14 for execution.

In the example of FIG. 5, the computer system 14 comprises a UNIX-based computer system. FIG. 5 relates to at least one input 12 comprising command ‘rm’.

In examples, the at least one input 12 is converted to digital form. For example, input ‘rm-f Target’ can be expressed in binary format, such as:

01110010 01101101 00100000 00101101 01100110 00100000 01010100 01100001 01110010 01100111 01100101 01110100.

Where:
command ‘rm’ is represented by 01110010 01101101 00100000 (including a space symbol),
option ‘-f’ is represented by 00101101 01100110 00100000 (including a space symbol)
filename ‘Target’ is represented 01010100 01100001 01110010 01100111 01100101 01110100.

Referring to FIG. 5, the at least one input 12 in this example is ‘rm’ and is represented by sub-columns in input set 36 (first column in FIG. 5). In FIG. 5, the term ‘r’ (01110010) is represented in the first column of the input set 36, the term ‘m’ (01101101) is represented in the second column of the input set 36, and the ‘space’ (00100000) is represented in the third column of the input set 36.

In examples, a galvanic separation function can be used. This can, for example, prevent software overruns or bypassing.

In examples, any suitable galvanic separation technique, for example an optic isolator, can be used to change an input 12, for example a command, to a form which can not be executed by computer system 14. In examples, the input 12 is transformed into a bit representation.

Accordingly, in examples, a logical separation for the input 12, for example a command, can be provided. See, for example, FIG. 10.

As illustrated in the example of FIG. 5, in examples eight isolators with static or hierarchic position can be used. In examples, each isolator can correspond to specified bit in byte (8 bits) word.

In examples when a character representation is used, the first column, for example in ASCII code, with reference to the letter “m”, the most significant bit with value 0 (on top) may be handled by the first isolator in the bank, whereas the last significant bit with value 1 (on bottom, middle sub-column of column 1) may correspond to the last isolator in the bank.

In examples, the method can be adapted to the given bit word length at the input. For example, larger words may be used, for example 16 bits or more.

In examples, if somehow bits are shifted, the input will not be allowed to pass to the computer system 14.

However, it could also mean that the input 12 may not be recognised by the filesystem due syntax error.

With respect to bitwise processing, 8 bits string (or longer) can be used and passed simultaneously via a filter bank.

Then, as described below, the output set (byte or longer) can be compared with a reference set. This can also be considered a bitwise operation.

In examples, the data is reconstructed at the output, which again can have an 8 bit representation. In examples, method 300 supports bitwise processing in an efficient way.

The third column of FIG. 5 represents an output set 40 that is determined based, at least in part, on the input set 36.

In the example of FIG. 5, byte words for the input 12 are determined based on binary value position. This is an example of encoding the at least one input (‘rm’) into a bit representation 26.

In the example of FIG. 5, the at least one input 12 is encoded into bit triplets, but in examples any suitable bit representation can be used. It can be seen in the example of FIG. 5 that the bit triplets are determined by reading across the columns representing the input 12. However, in examples a serial or parallel construction can be used and different byte encoding can be determined.

In examples, hex words can be used, this can allow, for example, larger words to be analysed.

In examples, each input 12, such as a command word, can have a unique output set 40 representation.

The fourth column in FIG. 5 represents a reference input set 24, indicated as ‘Command Set’ in the figure.

In the example of FIG. 5, in the reference input set 24, a byte representation of supported inputs, such as commands, is stored in the same form as the output set 24. However, any suitable reference input set 24 having any suitable form can be used.

In examples, the recognized and/or configured input(s) 12 have a representation in the reference input set 24 and the representation in the reference input set 24 can be used to control what happens to the at least one input 12.

This is therefore an example of how one or more inputs 12 can be prevented from execution and one or more inputs allowed to pass to computer system 14 for execution.

In the example of FIG. 5 inputs ‘mv’, ‘rm’, and ‘ls’ have representations in the reference input set 24. However, only the input ‘ls’ has its proper representation in the reference input set 24, which will allow input ‘ls’ to be passed for execution.

In the illustrated example, inputs ‘mv’ and ‘rm’ have empty (zeroes) as their representations in the reference input set 24 which will prevent inputs ‘mv’ and ‘rm’ from being passed for execution.

In examples, any suitable control logic can be used, and can be user specific.

In the fifth column 42, a logical comparison and/or verification is performed.

In the example of FIG. 5 a XNOR logical operator is used to perform the logical comparison and/or verification. However, in examples, any suitable logical function(s) can be used instead of and/or in addition to ‘XNOR’.

In examples, the output set 40 is compared with the columns of the reference input set 24.

In the example of FIG. 5, a logical “1” output from the XNOR operator means same value at each position is present. However, in examples, the output will depend on the logical operator(s) used. For example, a reference input set 24 configured to operate with logical operator ‘NOT’ will have a different bit representation compared to a reference input set 24 configured to operate with logical operator ‘XNOR’.

If the proper representation of an input 12 is present in the reference input set 24 a logical “1” will be detected at each position within the same column, which indicates that the output set 40 matches an allowed and/or supported computer system input and such input 12 can be passed to the computer system 14 for execution.

In the sixth column, an output result 44, matching command from reference input set 24 is converted for example to ASCII format and in such format is inputted to/passed to computer system 14 for execution. In examples, the output result 44 is converted to the same format as the at least one input 12.

In the example of FIG. 5, as the representation for the ‘rm’ input is null values, there is no match in the logical comparison and therefore there is no output result 44 to be passed to computer system 14 for execution. In this example, this therefore effectively blocks and/or filters input ‘rm’ regardless of associated authorisation.

In examples, instead of input ‘rm’ from output set 40 or input set 36, command rm¹ from reference input set 24 can be used as entry for output result 44, which can, for example, allow an input to be changed prior to execution by computer system. See, for example, FIG. 7.

However, if operation is to be transparent, for example for passing file content, for example text file, output set 40 may be used as entry for output result 44.

In examples, computer system 14 uses specific syntax and semantics, and/or general rules, which mean that filtering and/or comparison are effective.

FIG. 6 illustrates another example of determining if at least one input 12 should be passed to a computer system 14 for execution.

The example of FIG. 6 is similar to the example of FIG. 5. However, in the example of FIG. 6 the reference input set 24 includes proper representations for inputs ‘rm’ and ‘ls’ which are therefore acceptable and/or allowable inputs 12 in the example of FIG. 6.

However, input ‘mv’ is still represented by null values in the reference input set 24 of FIG. 6 and would therefore be blocked as described with regard to input ‘rm’ in relation to the example of FIG. 5.

In the example of FIG. 6, the input 12 is again ‘rm’ and the input set 36 and output set 40 are the same as in the example of FIG. 5.

However, in the example of FIG. 6 the logical comparison yields logical ‘1’s for each position and therefore the output result 44 is the input 12. This effectively allows the input 12 to be passed to the computer system 14 for execution, while still affecting input ‘mv’ differently.

In examples, the output result 44 can be different to output set 40. Accordingly, in examples, modification of inputs 12 based, at least in part, on defined logic can be made. This can, for example, make inputs 12 potentially less harmful for computer system 14.

For example, reference input set 24 can contain two representations for one or more given inputs 12: the first can be for use in the logical comparison, for example XNOR function, the second can be to be used as the output result 44.

In examples, if logical comparison verification is positive (all 1s), instead of the input 12, for example ‘rm’, a different input 12, for example ‘mv’ may be initiated instead, and the target, for example a filename, can be moved to dedicated directory instead of being removed. Thus, such file could be retrieved when needed.

By way of example, reference is made to FIG. 7.

FIG. 7 illustrates another example of determining if at least one input 12 should be passed to a computer system 14 for execution.

The example of FIG. 7 is similar to the example of FIG. 6. However, in the example of FIG. 6 the reference input set 24 includes two representations for the input ‘rm’, one for the logical comparison (to allow the input to be successfully verified), and one for output after successful verification.

In the example, of FIG. 7, the second representation is for the input ‘ls’ and therefore the output result 44 in the example of FIG. 7 is ‘ls’ instead of the input ‘rm’.

By way of example, reference is made to the example of FIG. 10.

FIG. 10 illustrates example scenarios.

In the example of FIG. 10, an input 12 is directed towards computer system 14, however device 30 involved in the example of FIG. 10 is configured to perform one or more methods described herein, for example method 300.

This is indicated in the example of FIG. 10 by the box labelled GSF 38 between the input 12 and the computer system 14.

In a first example, input 12a is received, indicated as ‘1’ in the example of FIG. 10 and is allowed to pass to computer system 14 as illustrated by arrow labelled ‘44a’, and input ‘1’ reaches computer system 14 as ‘1’.

In a second example, input 12b is received, as indicated as ‘1’ in the example of FIG. 10 and is not allowed to pass to computer system 14.

Instead, an input from reference set 24 is passed to computer system 14 as illustrated by arrow labelled 44b. In this way, a ‘0’ is passed to computer system 14 instead of the inputted ‘1’, effectively blocking the original input 12.

Accordingly, it can be seen from, at least, the examples of FIGS. 5, 6, 7 and 10 how the at least one input 12 can be blocked or changed. For example, a command, such as ‘rm’, or a target of a command can be blocked or changed.

In examples, based, at least in part, on computer system 14 syntax and semantic, executable procedures and/or commands can be recognized and distinguished from the content of transmitted or received files such as text file or bitmaps. Such received files may be allowed to pass to computer system 14. In such examples, output set 40 can be directly converted to output result 44.

In examples, from the point of view of computer system 14, output result 44 should have the same form and format as input set, that is output result 44 should be recognizable by computer system 14.

Referring to FIG. 3, if the determination at block 304 is negative, method 300 proceeds to block 308, and if the determination at block 304 is positive, method 300 proceeds to block 310.

At block 308, method 300 comprises preventing execution of the at least one input 12 by the computer system 14.

Consequently, FIG. 3 illustrates a method 300 comprising:

receiving at least one input 12 for execution by a computer system 14, wherein the at least one input 12 is received with appropriate authorization 16 for execution by the computer system 14;
determining if the at least one input 12 should be passed to the computer system 14 for execution; and
if it is determined that the at least one input 12 should not be passed to the computer system 14 for execution, preventing execution of the at least one input by the computer system 14.

In examples, preventing execution of the at least one input by the computer system 14 can be performed in any suitable way using any suitable method.

In examples, preventing execution of the at least one input 12 comprises blocking or changing the at least one input 12.

In examples, blocking or changing the at least one input 12 can be performed in any suitable way using any suitable method. In examples, blocking or changing the at least one input 12 can be based, at least in part, on one or more actions performed at block 304.

In examples, blocking or changing the at least one input 12 comprises controlling output after a comparison with a reference input set 24 is made. See, for example, FIGS. 5, 6 and/or 7.

In examples, changing the at least one input 12 comprises changing at least one command 18 of the at least one input 12 and/or changing at least one target 20 of the at least one input 12. See, for example, FIG. 7.

For example, access to file ‘Target’ can be restricted such that when at least one input 12 is received involving ‘Target’, for example command rm-f Target, filename ‘Target’ is changed to another one, for example Target_Fake, using similar principles as shown in FIG. 7.

In this way, computer system 14 can receive command rm-f Target_Fake but a user trying to remove ‘Target’ will think the file having filename ‘Target’ has been removed.

In examples, method 300 comprises changing an output 54 caused by at least one input 12. In examples, preventing execution of the at least one input 12 by the computer system 14 can be considered to comprise changing an output 54 caused by at least one input 12.

In examples, changing an output 54 caused by at least one input 12 can be performed in any suitable way using any suitable method. In examples, changing an output 54 caused by at least one input 12 comprises changing the at least one input, for example changing a command 18 and/or target 20 of the at least one input 12.

Accordingly, in examples, method 300 can be applied at a device output, where, for example, data outputted from software-controlled device 30 can be controlled, using similar principles.

For example, content replacing function, as illustrated in the example of FIG. 7, can be used to prevent, for example, sensitive data leakage. For example, instead of printing Target_Fake filename using command ls, the filename can be replaced by Target filename. Thus, an unauthorized user may be convinced about successful malicious attack on software-controlled device, whereas in fact, software was not changed. This also can give insight as to whether an attack had taken place.

At block 310, method 300 comprises passing the at least one input 12 for execution by the computer system 14.

Accordingly, in examples, method 300 comprises if it is determined that the at least one input 12 should be passed to the computer system 14 for execution, passing the at least one input for execution by the computer system 14.

In examples, passing the at least one input for execution by the computer system 14 can be performed in any suitable way using any suitable method. In examples, passing the at least one input 12 can be based, at least in part, on one or more actions performed at block 304.

In examples, passing at least one input 12 to a computer system 14 for execution can be considered transmitting at least one input 12, communicating at least one input 12, allowing at least one input to pass, sending at least one input 12, conveying at least one input 12, and/or communicating at least one input 12 to a computer system 14 for execution.

In examples, passing the at least one input 12 for execution by the computer system 14 comprises transmitting one or more signals to a separate device 30.

In examples, passing the at least one input 12 for execution by the computer system 14 comprises performing one or more actions internally in a device 30.

In examples, if the at least one input 12 comprises incorrect data due syntax or semantic error, such input(s) will not be executed by computer system 14 due to the error(s). In such examples, the at least one input 12 can be passed to computer system 14 as no harm can ensue, or can be blocked/filtered which can provide savings in processing time.

In examples, method 300 comprises making one or more changes to the one or more inputs 12 that are acceptable and/or that should be passed for execution by the computer system 14.

For example, method 300 can comprise making one or more changes to one or more reference input sets 24.

In examples, method 300 comprises determining that a state of an apparatus 10 and/or device 30 should be changed, to allow one or more changes to be made.

In examples, determining that a state of an apparatus 10 and/or device 30 should be changed comprises determining that an authorized physical device 28 has been physically connected to a device 30 and/or apparatus.

Accordingly, in examples, changes to the method 300 can only be made by use of an authorized physical device 28.

In examples, determining that an authorized physical device 28 has been connected to a device comprises and/or can be considered determining that an authorized physical device has been activated.

In examples, method 300 comprises determining that an authorized physical device 28 has been physically connected to a device 30; and based, at least in part, on determining that the authorized physical device 28 has been physically connected, changing a state of the apparatus 10.

In examples the authorized physical device 28 can have any suitable form. For example, the authorized physical device 28 can comprise any suitable physical device.

In examples, the authorized physical device 28 comprises memory in which at least one reference set is stored, the reference input set 24 of the authorized physical device 28 for use instead of the reference input set 24 when the authorized physical device 28 is in use.

In examples, the authorized physical device can be considered a key.

In examples, determining that an authorized physical device 28 has been physically connected to a device 30 can be performed in any suitable way using any suitable method.

In examples, one or more signals are transmitted between the physical device 28 and the apparatus 10/device 30 comprising information to authorize the physical device 28. For example, one or more shared secrets can be used to authorize the physical device 28.

In examples, the authorized physical device 28 can be considered physically connected to a device 30 when it is brought close enough to allow short range signals to be transferred between the authorized physical device 28 and the device 30.

For example, the authorized physical device 28 can be considered physically connected to the device 30 when it is brought close enough to allow a short-range local connection to be formed between the device 30 and the physically authorized device 28.

Accordingly, in examples, physically connecting the authorized physical device 28 to the device 30 does not involve physically attaching the authorized physical device 28 to the device 30.

In examples, changing a state of the apparatus 10 comprises changing how determining if the at least one input 12 should be passed to the computer system 14 for execution is performed.

In examples, how determining if the at least one input 12 should be passed to the computer system 14 for execution can be changed in any suitable way.

In examples, a change to how determining if the at least one input 12 should be passed to the computer system 14 for execution can endure after removal of the authorized physical device 28 or can end based, at least in part, on removal of the authorized physical device 28.

In examples, changing a state of the apparatus 10 comprises allowing changes to how the apparatus 10 performs determining if the at least one input 12 should be passed to the computer system 14 for execution.

In examples, changing how determining if the at least one input 12 should be passed to the computer system 14 for execution is performed comprises changing a reference input set 24 or bypassing the determination.

In examples, physically connecting an authorised physical device 28 disables the determination, which means, for example, that one or more inputs 12 can be directly exchanged between input/output user devices and computer system 14. See, for example, FIG. 9E. In such examples, the authorized physical device 28 can be considered and/or can be considered to act as a bridge or bypass.

In examples, the authorised physical device 28 contains one or more reference input sets 24, which can supersede the reference input set(s) used at block 304 when the authorised physical device 28 is mounted or switched. See, for example, FIG. 9D.

In examples, connecting and/or switching and/or mounting of the authorised physical device 28 should be performed by authorized user.

In examples, this action is possible only when software-controlled device 30 is in a predetermined mode, which can be considered a maintenance mode.

In examples, change of the device 30 to the predetermined mode can be clearly signalled to a user, ensuring that the user is aware of the use of the authorized physical device 28.

In examples, changing of the device 30 into the predetermined mode occurs upon authorisation by the user. In examples, authorisation can be provided in any suitable way. For example, using one or more inputs and/or two-factor authorisation and so on.

In examples, changing to the predetermined mode comprises physical interaction with the device 30. Physical activation means that this kind of action cannot be performed or triggered by software itself, preventing software being hacked or modified by an unauthorized user.

In examples, changing to the predetermined mode comprises the device 30 being in a predetermined state to allow the device 30 to be changed to the predetermined mode.

For example, in examples involving an autonomous vehicle, the autonomous car needs to be first stopped or parked to unlock maintenance mode. Then the user may activate maintenance mode by physical activation.

Use of a predetermined mode can allow, for example, a user to be made aware about software modifications and may perform necessary calibrations or checking if needed, to prevent from malicious software installation and its impact on the device performance.

Use of an authorised physical device 28 in this way can prevent from accidental security breach, where for example a user may connect a mobile phone, for example, using USB port to any sensitive software-controlled device.

Use of an authorised physical device 28 can be configured also to prevent from installation any software during normal operation. Any software updates may be possible for example with use of the authorised physical device 28, after which the device 30 may be calibrated or verified.

Examples of the disclosure are advantageous and provide technical benefits.

For example, examples of the disclosure provide for protection of a computer system, such as a filesystem of operating system, regardless of user access rights.

For example, examples of the disclosure provide for protection of a computer system even when login credentials, such as username and password, have been stolen and/or intercepted.

For example, examples of the disclosure provide for protection of a computer system in a way that is transparent to an attacker, allowing the attacker to think that the attack has been successful without affecting computer system.

For example, examples of the disclosure protect computer system against uncontrolled autobooting or automounting, when, for example, computer system may automatically synchronise with an inserted USB memory stick, or with other device wire or wirelessly connected.

For example, examples of the disclosure improve security of newly established interface by controlling and/or filtering input and output traffic and data. In examples, only supported/accepted procedures, instructions, functions, commands, options executed on specified directories or files may executed by computer system.

FIG. 4 illustrates an example scenario.

In the example of FIG. 4, actions involving a user 34 are indicated on the left of FIG. 4 and actions performed by a device 30 are indicated on the right side of FIG. 4.

In the example of FIG. 4, an input 12 ‘rm-f Target’ is inputted by the user 34 into a device 30 via an input interface 32.

The device 30 in the example of FIG. 4 comprises an apparatus 10 configured to perform one or more methods described herein, for example method 300. In examples, the device 30 can be considered an apparatus configured to perform one or more methods described herein, for example method 300.

This is indicated in the example of FIG. 4 by the box labelled galvanic separation filter (GSF) 38 through which the input is illustrated as passing.

In the example of FIG. 5, GSF 38 does not allow command ‘rm’ to pass to computer system 14 and therefore no action (‘null’) is executed by computer system 14.

Accordingly, in the example of FIG. 5, command ‘rm’ may not be passed, even if user has proper rights to execute such a command. However, in the illustrated example, command ‘ls’ may be successfully passed and executed by computer system 14.

This is advantageous as, for example, if improperly used, command ‘rm’ can be used to remove certain files, which may damage computer system 14 itself or user files or configuration settings may be removed and so on. As such, in examples, command ‘rm’ may be considered as potentially dangerous. In examples, any input or inputs 12 can be treated in this way.

FIG. 8 illustrates an example scenario.

In the example of FIG. 8, Air Traffic Control (ATC) System 46 and Flight Management System (FMS) 52 may be examples of sensitive system, which should be protected against unauthorized access to computer system 14. In the example of FIG. 8 ATC 46 and FMS can communicate via network 48.

In order to reflect correct airborne situation awareness, ATC 46 may require certain data, such as identity or height from airborne aircraft. These data are needed for aircraft positioning and safety network management.

Currently, it may be possible to connect mobile phone to FMS 52 for navigation, communication, and surveillance purpose. In such case, there may be a risk that malicious software may be unnoticeably installed on FMS 46 or ATC 52 system, especially if hacker 50 intercepts administrator login and password.

However, FIG. 8, if examples of the disclosure are implemented, for example GSF is installed at sensitive system interfaces, for example between user's mobile phone 30 and FMS 52, unwanted content may be easily filtered out.

As illustrated in the example of FIG. 8, ATC 52 system requires only certain data, which may be characterized as requests, similar way to commands or procedures. Thus, GSF may be configured to accept only such defined commands or procedures. Other procedures or commands, even essential such as command Is may not be passed through the filter as input data.

Once supported command or procedure is received via GSF by FMS 52, for example, IDENTITY REQ, FMS may answer as specified by IDENTITY RESP. Note that GSF may also prevent from transmission from FMS 52 any other content, which may not be expected by ATC 46 system and which may be potentially caused by malicious software, which may be already present at FMS 52.

Thus, enhanced security protection may be achieved in two way: at input and at output of software-controlled device.

As illustrated by the example of FIG. 8. Examples of the disclosure can be effective for enhanced security protection for any sensitive software-controlled systems such as Air Traffic Control, Oil Pipelines Management, Banks, Autonomous Cars, IoT Sensors and so on, in which typical input/output interactions via wire or wireless interfaces may be limited to specified number of procedures, commands or data.

FIGS. 9A to 9E illustrate a number of example scenarios.

In the example of FIG. 9A, an example where input 12 comprising command ‘rm’ is allowed to pass through GSF 38 and is therefore executed by computer system 14 resulting in output 54 via output interface 34.

The example of FIG. 9B is similar to the example of FIG. 9A, but in the example of FIG. 9B command ‘rm’ is not allowed to pass for execution by computer system 14 and is blocked. Accordingly, the command is not executed and the Target file remains as indicated in the output via output interface 34.

The example of FIG. 9C is similar again but illustrates an example where command ‘rm’ is allowed to pass but its meaning is replaced by command ‘ls’. This means that command ‘ls’ is executed instead of command ‘rm’ as indicated in the output 54.

The example of FIG. 9D is similar again but illustrates an example in which an authorized physical device 28, labelled GSF key, is connected and/or activated and/or installed to allow full and direct access to computer system 14.

In examples, such action may be signalled to user, for example by switching to maintenance mode. In the example of FIG. 9E, the authorized physical device 28 overruns the protection settings.

The example of FIG. 9E is similar again but illustrates an example in which an authorizes physical device 28, labelled GSF key, is connected and/or activated and/or installed to as a bridge to overrun GSF 38.

Examples of the disclosure are advantageous and provide technical benefits.

For example, examples of the disclosure provide protection for a computer system 14 even when access rights have been stolen and/or intercepted.

FIG. 10A illustrates an example of a controller 1030. The controller 1030 can be used in an apparatus, such as an apparatus 10 of FIG. 1 and/or FIG. 2A and/or FIG. 2B. In some examples, controller 1030 can be considered and apparatus 10.

Implementation of a controller 1030 may be as controller circuitry. The controller 1030 may be implemented in hardware alone, have certain aspects in software including firmware alone or can be a combination of hardware and software (including firmware).

As illustrated in FIG. 10A the controller 1030 may be implemented using instructions that enable hardware functionality, for example, by using executable instructions of a computer program 1036 in a general-purpose or special-purpose processor 1032 that may be stored on a computer readable storage medium (disk, memory etc) to be executed by such a processor 1032.

The processor 1032 is configured to read from and write to the memory 1034. The processor 1032 may also comprise an output interface via which data and/or commands are output by the processor 1032 and an input interface via which data and/or commands are input to the processor 1032.

The memory 1034 stores a computer program 1036 comprising computer program instructions (computer program code) that controls the operation of the apparatus when loaded into the processor 1032. The computer program instructions, of the computer program 1036, provide the logic and routines that enables the apparatus to perform the methods illustrated in FIG. 3, and/or FIG. 4, and/or FIG. 5, and/or FIG. 6, and/or FIG. 7 and/or FIG. 8, and/or any of FIGS. 9A to 9E, and/or FIG. 10, and/or as described herein. The processor 1032 by reading the memory 1034 is able to load and execute the computer program 1036.

The apparatus therefore comprises:

at least one processor 1032; and
at least one memory 1034 including computer program code
the at least one memory 1034 and the computer program code configured to, with
the at least one processor 1032, cause the apparatus at least to perform:
receiving at least one input for execution by a computer system, wherein the at least one input is received with appropriate authorisation for execution by the computer system;
determining if the at least one input should be passed to the computer system for execution; and
if it is determined that the at least one input should not be passed to the computer system for execution, preventing execution of the at least one input by the computer system.

As illustrated in FIG. 10A, the computer program 1036 may arrive at the apparatus via any suitable delivery mechanism 1062. The delivery mechanism 1062 may be, for example, a machine readable medium, a computer-readable medium, a non-transitory computer-readable storage medium, a computer program product, a memory device, a record medium such as a Compact Disc Read-Only Memory (CD-ROM) or a Digital Versatile Disc (DVD) or a solid state memory, an article of manufacture that comprises or tangibly embodies the computer program 1036. The delivery mechanism may be a signal configured to reliably transfer the computer program 1036. The apparatus may propagate or transmit the computer program 1036 as a computer data signal.

Computer program instructions for causing an apparatus to perform at least the following or for performing at least the following:
receiving at least one input for execution by a computer system, wherein the at least one input is received with appropriate authorisation for execution by the computer system;
determining if the at least one input should be passed to the computer system for execution; and
if it is determined that the at least one input should not be passed to the computer system for execution, preventing execution of the at least one input by the computer system.
   The computer program instructions may be comprised in a computer program, a non-transitory computer readable medium, a computer program product, a machine readable medium. In some but not necessarily all examples, the computer program instructions may be distributed over more than one computer program.

Although the memory 1034 is illustrated as a single component/circuitry it may be implemented as one or more separate components/circuitry some or all of which may be integrated/removable and/or may provide permanent/semi-permanent/dynamic/cached storage.

In examples, the memory 1034 comprises a random-access memory 1058 and a read only memory 1060. In examples, the computer program 1036 can be stored in the read only memory 1060.

Although the processor 1032 is illustrated as a single component/circuitry it may be implemented as one or more separate components/circuitry some or all of which may be integrated/removable. The processor 1032 may be a single core or multi-core processor.

References to ‘computer-readable storage medium’, ‘computer program product’, ‘tangibly embodied computer program’ etc. or a ‘controller’, ‘computer’, ‘processor’ etc. should be understood to encompass not only computers having different architectures such as single/multi-processor architectures and sequential (Von Neumann)/parallel architectures but also specialized circuits such as field-programmable gate arrays (FPGA), application specific circuits (ASIC), signal processing devices and other processing circuitry. References to computer program, instructions, code etc. should be understood to encompass software for a programmable processor or firmware such as, for example, the programmable content of a hardware device whether instructions for a processor, or configuration settings for a fixed-function device, gate array or programmable logic device etc.

As used in this application, the term ‘circuitry’ may refer to one or more or all of the following:
(a) hardware-only circuitry implementations (such as implementations in only analog and/or digital circuitry) and
(b) combinations of hardware circuits and software, such as (as applicable):
(i) a combination of analog and/or digital hardware circuit(s) with software/firmware and
(ii) any portions of hardware processor(s) with software (including digital signal processor(s)), software, and memory(ies) that work together to cause an apparatus, such as a mobile phone or server, to perform various functions and
(c) hardware circuit(s) and or processor(s), such as a microprocessor(s) or a portion of a microprocessor(s), that requires software (e.g. firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor and its (or their) accompanying software and/or firmware. The term circuitry also covers, for example and if applicable to the particular claim element, a baseband integrated circuit for a mobile device or a similar integrated circuit in a server, a cellular network device, or other computing or network device.

The blocks illustrated in the FIGS. 3 and/or 4 and/or 5 and/or 6 and/or 7 and/or 8 and/or any of 9a to 9E and/or as described herein may represent steps in a method and/or sections of code in the computer program 1036. The illustration of a particular order to the blocks does not necessarily imply that there is a required or preferred order for the blocks and the order and arrangement of the block may be varied. Furthermore, it may be possible for some blocks to be omitted.

Where a structural feature has been described, it may be replaced by means for performing one or more of the functions of the structural feature whether that function or those functions are explicitly or implicitly described.

Thus the apparatus can comprise means for:
receiving at least one input for execution by a computer system, wherein the at least one input is received with appropriate authorisation for execution by the computer system;
determining if the at least one input should be passed to the computer system for execution; and
if it is determined that the at least one input should not be passed to the computer system for execution, preventing execution of the at least one input by the computer system.

In examples, an apparatus can comprise means for performing one or more methods, and/or at least part of one or more methods, as disclosed herein.

In examples, an apparatus can be configured to perform one or more methods, and/or at least part of one or more methods, as disclosed herein.

The above described examples find application as enabling components of: automotive systems; telecommunication systems; electronic systems including consumer electronic products; distributed computing systems; media systems for generating or rendering media content including audio, visual and audio visual content and mixed, mediated, virtual and/or augmented reality; personal systems including personal health systems or personal fitness systems; navigation systems; user interfaces also known as human machine interfaces; networks including cellular, non-cellular, and optical networks; ad-hoc networks; the internet; the internet of things; virtualized networks; and related software and services.

The term ‘comprise’ is used in this document with an inclusive not an exclusive meaning. That is any reference to X comprising Y indicates that X may comprise only one Y or may comprise more than one Y. If it is intended to use ‘comprise’ with an exclusive meaning then it will be made clear in the context by referring to “comprising only one . . . ” or by using “consisting”.

In this description, reference has been made to various examples. The description of features or functions in relation to an example indicates that those features or functions are present in that example. The use of the term ‘example’ or ‘for example’ or ‘can’ or ‘may’ in the text denotes, whether explicitly stated or not, that such features or functions are present in at least the described example, whether described as an example or not, and that they can be, but are not necessarily, present in some of or all other examples. Thus ‘example’, ‘for example’, ‘can’ or ‘may’ refers to a particular instance in a class of examples. A property of the instance can be a property of only that instance or a property of the class or a property of a sub-class of the class that includes some but not all of the instances in the class. It is therefore implicitly disclosed that a feature described with reference to one example but not with reference to another example, can where possible be used in that other example as part of a working combination but does not necessarily have to be used in that other example.

Although examples have been described in the preceding paragraphs with reference to various examples, it should be appreciated that modifications to the examples given can be made without departing from the scope of the claims.

Features described in the preceding description may be used in combinations other than the combinations explicitly described above.

Although functions have been described with reference to certain features, those functions may be performable by other features whether described or not.

Although features have been described with reference to certain examples, those features may also be present in other examples whether described or not.

The term ‘a’ or ‘the’ is used in this document with an inclusive not an exclusive meaning. That is any reference to X comprising a/the Y indicates that X may comprise only one Y or may comprise more than one Y unless the context clearly indicates the contrary. If it is intended to use ‘a’ or ‘the’ with an exclusive meaning then it will be made clear in the context. In some circumstances the use of ‘at least one’ or ‘one or more’ may be used to emphasis an inclusive meaning but the absence of these terms should not be taken to infer any exclusive meaning.

The presence of a feature (or combination of features) in a claim is a reference to that feature or (combination of features) itself and also to features that achieve substantially the same technical effect (equivalent features). The equivalent features include, for example, features that are variants and achieve substantially the same result in substantially the same way. The equivalent features include, for example, features that perform substantially the same function, in substantially the same way to achieve substantially the same result.

In this description, reference has been made to various examples using adjectives or adjectival phrases to describe characteristics of the examples. Such a description of a characteristic in relation to an example indicates that the characteristic is present in some examples exactly as described and is present in other examples substantially as described.

Whilst endeavoring in the foregoing specification to draw attention to those features believed to be of importance it should be understood that the Applicant may seek protection via the claims in respect of any patentable feature or combination of features hereinbefore referred to and/or shown in the drawings whether or not emphasis has been placed thereon.

I/we claim:

1-44. (canceled)

45. An apparatus comprising
at least one processor; and
at least one memory including computer program code;
the at least one memory and the computer program code configured to, with the at least one processor, cause the apparatus to perform:
receiving at least one input for execution by a computer system, wherein the at least one input is received with appropriate authorisation for execution by the computer system;
determining if the at least one input should be passed to the computer system for execution;
wherein determining if the at least one input should be passed to the computer system comprises encoding the at least one input into a bit representation for comparison with a reference input set; and
if it is determined that the at least one input should not be passed to the computer system for execution, preventing execution of the at least one input by the computer system.

46. An apparatus as claimed in claim 45, the at least one memory and computer program code configured to, with the at least one processor, cause the apparatus to perform:
if it is determined that the at least one input should be passed to the computer system for execution, passing the at least one input for execution by the computer system.

47. An apparatus as claimed in claim 45, wherein preventing execution of the at least one input comprises blocking or changing the at least one input.

48. An apparatus as claimed in claim 47, wherein changing the at least one input comprises changing at least one command of the at least one input and/or changing at least one target of the at least one input.

49. An apparatus as claimed in claim 45, wherein appropriate authorisation comprises authorisation for the at least one input to pass through any firewalls protecting the computer system.

50. An apparatus as claimed in claim 45, wherein appropriate authorisation comprises administrator authorisation for the computer system.

51. An apparatus as claimed in claim 45, wherein the computer system comprises a filesystem and/or operating system.

52. An apparatus as claimed in claim 45, wherein the reference input set is user defined.

53. An apparatus as claimed in claim 45, wherein if there is a match between the at least one input and the reference input set, the at least one input is accepted for execution by the computer system.

54. An apparatus as claimed in claim 45, wherein the at least one input comprises one or more of:
a command;
a procedure;
an instruction;
a function; and
an option.

55. An apparatus as claimed in claim 45, the at least one memory and the computer program code configured to, with the at least one processor, cause the apparatus to perform:
determining that an authorised physical device has been physically connected to a device; and
based, at least in part, on determining that the authorised physical device has been physically connected, changing a state of the apparatus.

56. An apparatus as claimed in claim 55, wherein changing a state of the apparatus comprises changing how the apparatus performs determining if the at least one input should be passed to the computer system for execution.

57. An apparatus as claimed in claim 56, wherein changing how the apparatus performs determining if the at least one input should be passed to the computer system for execution comprises changing a reference input set or bypassing the determination.

58. An apparatus as claimed in claim 45, the at least one memory and the computer program code configured to, with the at least one processor, cause the apparatus to perform:
changing an output caused by at least one input.

59. A method comprising:
receiving at least one input for execution by a computer system, wherein the at least one input is received with appropriate authorisation for execution by the computer system;
determining if the at least one input should be passed to the computer system for execution;
wherein determining if the at least one input should be passed to the computer system comprises encoding the at least one input into a bit representation for comparison with a reference input set; and
if it is determined that the at least one input should not be passed to the computer system for execution, preventing execution of the at least one input by the computer system.

60. A method as claimed in claim 59, the method comprising:
If it is determined that the at least one input should be passed to the computer system for execution, passing the at least one input for execution by the computer system.

61. A method as claimed in claim 59, wherein preventing execution of the at least one input comprises blocking or changing the at least one input.

62. A method as claimed in claim 61, wherein changing the at least one input comprises changing at least one command of the at least one input and/or changing at least one target of the at least one input.

63. A method as claimed in claim 59, wherein appropriate authorisation comprises authorisation for the at least one input to pass through any firewalls protecting the computer system.

64. A non-transitory computer readable medium comprising program instructions that, when executed by an apparatus, cause the apparatus to perform at least the following:
receiving at least one input for execution by a computer system, wherein the at least one input is received with appropriate authorisation for execution by the computer system;
determining if the at least one input should be passed to the computer system for execution;
wherein determining if the at least one input should be passed to the computer system comprises encoding the at least one input into a bit representation for comparison with a reference input set; and
if it is determined that the at least one input should not be passed to the computer system for execution, preventing execution of the at least one input by the computer system.
